(19) United States
(12) Patent Application Publication
(10) Pub. No.: US 2022/0229353 A1
(43) Pub. Date: Jul. 21, 2022

(54) LARGE COLOR GAMUT LASER LIGHT SOURCE SYSTEM INTEGRATED BY NOTCH COMBINING BEAM

(71) Applicant: JINMEI LASERTEC CORP., LTD, Shanxi (CN)

(72) Inventors: HAIYANG CHEN, Shanxi (CN); YUANYUAN HU, Shanxi (CN); HUI LI, Shanxi (CN); QING GUO, Shanxi (CN)

(21) Appl. No.: 17/418,021

(22) PCT Filed: Oct. 10, 2020
(86) PCT No.: PCT/CN2020/120176

§ 371 Date: Jun. 24, 2021

(30) Foreign Application Priority Data
Oct. 11, 2019 (CN) 201910960747.4

(51) Int. Cl. G03B 21/20; G02B 27/14

(52) U.S. Cl. CPC G03B 21/204; G02B 27/141; G03B 21/2013

(57) ABSTRACT

The present disclosure discloses a large color gamut laser light source system integrated by a notch combining beam, wherein the light beam emitted by a blue laser light source I 1 is incident to a light guide tube 12 through a reflecting-green transmitting-blue beam combining mirror 2, a light homogenizing plate I4a, a reflecting-red transmitting-blue-green beam combining mirror 6, a red notch filter 10 and a lens group II 11 in sequence; the light beam emitted by a green laser light source 3 is incident to the light guide tube 12 through the reflecting-green transmitting-blue beam combining mirror 2, the light homogenizing plate I4a, the reflecting-red transmitting-blue-green beam combining mirror 6, the red notch filter 10 and the lens group II 11 in sequence.

### CROSS REFERENCE TO RELATED APPLICATION(S)

This application claims priority from the Chinese patent application filed in China National Intellectual Property Administration on Oct. 11, 2019 having the Application NO. 201910960747.4 and entitled as “Large Color Gamut Laser Light Source System Integrated By Notch Combining Beam”, the entire content of which is incorporated in this application by reference.

### TECHNICAL FIELD

The present disclosure relates to the technical field of laser projection, in particular to a large color gamut laser light source system integrated by a notch combining beam.

### BACKGROUND ART

A projector, as one of the most important devices in the display industry, has been widely used in various industries such as education, commerce, engineering, monitoring, simulation training and cinema screening since its birth. However, in the global market, lamp bulbs such as xenon lamps and high-pressure mercury lamps which are widely used in projectors are short in service life, poor in color, limited in brightness, high in use cost and not environmental-friendly, which have been difficult to keep pace with the times and cannot meet the requirements of continuously working for 24 hours a day and 7 days a week, such as new industry application requirements, such as a lighting real scene of control and monitoring rooms and large buildings. The Red, Green and Blue (RGB) laser projection display technology can truly reproduce the rich and gorgeous colors of the objective world, providing a more powerful expressive force, and having the characteristics of high brightness, long life, low using cost and environmental protection, which is regarded as the ultimate display technology in the display industry.

The high definition and the wide color gamut of a projection display are the pursuit of high-quality image in the industry. The definition has been upgraded from 1080p to 2k, and now it has been further upgraded to 4k. The color gamut has been expanded from Rec.709 to DCI-P3. Under the 4k high-definition display, the Rec.2020 color gamut comes into being, which is the new requirement of the industry for the perfect expression of the extreme color of the display screen.

However, at present, the commercially available green semiconductor laser diodes at home and abroad (low price, long service life and wide working temperature adaptation range) have only the wavelengths of 520 nm and 525 nm, neither of which can cover the color gamut Rec.2020 as shown in FIG. 3. In order to cover Rec.2020, a 532 nm laser must be used. At present, only solid-state lasers can produce 532 nm green laser, but the price of this laser is too high, and the luminous stability is strongly influenced by the working temperature, so that it is difficult to be commercialized in the projection industry.

### SUMMARY

In view of the above, the present disclosure provides a large color gamut laser light source system integrated by a notch combining beam, which uses a novel optical path of a red notch filter to couple and integrate a semiconductor RGB laser diode and a laser fluorescent unit, and proposes an integrated light source system closely packing the laser with a large color gamut through a notch combining beam, which can effectively solve the technical problem that the existing integrated light source coupled by a semiconductor RGB laser diode does not meet the color gamut Rec.2020.

To achieve the above purpose, the present disclosure provides the following scheme.

The present disclosure relates to a large color gamut laser light source system integrated by a notch combining beam, comprising a blue laser light source I, a reflecting-green transmitting-blue beam combining mirror, a green laser light source, a blue excitation light source, a reflecting-red transmitting-blue-green beam combining mirror, a fluorescent unit and a red laser light source;

wherein the light beam emitted by the blue laser light source I is incident to a light guide tube through the reflecting-green transmitting-blue beam combining mirror, a light homogenizing plate I, the reflecting-red transmitting-blue-green beam combining mirror, a red notch filter and a lens group II in sequence;

the light beam emitted by the green laser light source is incident to the light guide tube through the reflecting-green transmitting-blue beam combining mirror, the light homogenizing plate I, the reflecting-red transmitting-blue-green beam combining mirror, the red notch filter and the lens group II in sequence;

the light beam emitted by the blue excitation light source is incident to the fluorescent unit through the light homogenizing plate II, the reflecting-red transmitting-blue-green beam combining mirror and a lens group I in sequence;

the light beam emitted by the fluorescent unit is incident to the light guide tube through the lens group I, the reflecting-red transmitting-blue-green beam combining mirror, the red notch filter and the lens group II in sequence;

the light beam emitted by the red laser light source is incident to the light guide tube through the light homogenizing plate III, the red notch filter and the lens group II in sequence.

Preferably, the fluorescent material of the fluorescent unit is fluorescent ceramic, fluorescent crystal or fluorescent powder.

Preferably, the fluorescent material generates color light of >532 nm under the irradiation of the blue excitation light source.

Preferably, the beams transmitted or reflected by the beam combining mirror are incident at an angle of 45 degrees.

Preferably, the optical characteristics of the red notch filter 10 are reflecting the light source with a wavelength in the band of 620 nm-660 nm and transmitting the light source with a wavelength in the two bands of 400 nm-620 nm and 660 nm-700 nm.

Preferably, the fluorescent unit is constructed by a blue laser diode and a fluorescent material adapted to the wavelength of the blue laser diode.

According to the specific embodiment provided by the present disclosure, the present disclosure discloses the following technical effects.

The laser light source manufactured in the prior art comprises laser light source made of red, green and blue semiconductor laser diodes, which cannot meet the requirements of large color gamut Rec.2020. The color gamut of the laser light source can meet the requirements of large color gamut Rec.2020 through the scheme of the present disclosure.

The laser light source manufactured in the prior art further comprises a solid-state laser, which can also meet the requirements of large color gamut Rec.2020, but it has high cost and large volume. At the same time, the environment temperature required for stable operation of laser light source is harsh, which is difficult to be commercialized in projection industry, hindering the popularization and use of laser display technology. With the implementation of the present disclosure, a large color gamut laser light source which is small in volume, high in energy efficiency, loose in working environment requirements, capable of meeting the requirements of large color gamut Rec.2020, and high in cost performance can be produced, which fully meets the requirements of batch and commercialization.

The present disclosure is reasonable in design. A coupling integration system of the RGB laser light source realizes the coupling mode of multi-light source, high efficiency and ultra-small volume, which can meet the requirements of large color gamut Rec.2020, and is high in cost performance, wide in working temperature adaptation range, and good in practical application value.

### BRIEF DESCRIPTION OF THE DRAWINGS

In order to explain the embodiments of the present disclosure or the technical scheme in the prior art more clearly, the drawings needed in the embodiments will be briefly introduced hereinafter. Obviously, the drawings in the following description are only some embodiments of the present disclosure. For those skilled in the art, other drawings can be obtained according to these drawings without paying creative labor.

FIG. 1 shows a schematic diagram of a laser light source system according to the present disclosure;

FIG. 2 shows a spectrum diagram of effective fluorescence utilized by the laser light source system according to the present disclosure;

FIG. 3 shows a color gamut graph under different color gamut;

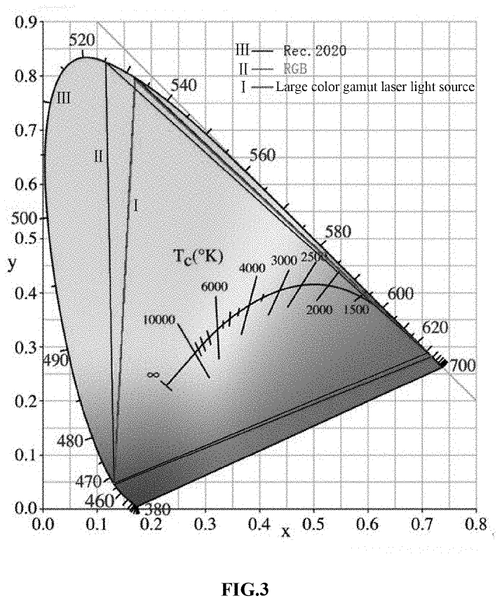

FIG. 4 shows a spectral graph of a notch filter;

FIG. 5 shows a schematic diagram that the light sources with two color coordinates are mixed to form a new color coordinate to meet the requirements of REC2020;

In the drawings: 1—blue laser source I, 2—reflecting-green transmitting-blue beam combining mirror, 3—green laser source, 4a—light homogenizing plate I, 4b—light homogenizing plate II, 4c—light homogenizing plate III, 5—blue excitation light source, 6—reflecting-red transmitting-blue—green beam combining mirror, 7—fluorescent unit, 8—lens group I, 9—red laser source, 10—red notch filter, 11—lens group II, 12—light guide tube.

### DETAILED DESCRIPTION OF THE EMBODIMENTS

The technical scheme in the embodiments of the present disclosure will be described clearly and completely hereinafter with reference to the drawings in the embodiments of the present disclosure. Obviously, the described embodiments are only some embodiments of the present disclosure, rather than all of the embodiments. Based on the embodiments of the present disclosure, all other embodiments obtained by those skilled in the art without paying creative labor belong to the scope of protection of the present disclosure.

The purpose of the present disclosure is to provide a large color gamut laser light source system integrated by a notch combining beam, which effectively solves the technical problem that the existing integrated light source coupled by a semiconductor RGB laser diode does not meet the color gamut Rec.2020.

In order to make the above objects, features and advantages of the present disclosure more obvious and understandable, the present disclosure will be further explained in detail hereinafter with reference to the drawings and specific embodiments.

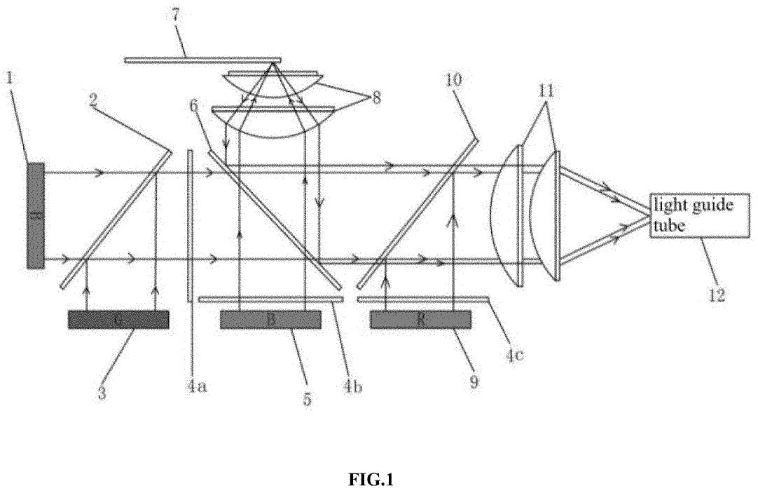

FIG. 1 shows a schematic diagram of a laser light source system according to the present disclosure. As shown in FIG. 1, a large color gamut laser light source system integrated by a notch combining beam comprises a blue laser light source I 1, a reflecting-green transmitting-blue beam combining mirror 2, a green laser light source 3, a blue excitation light source 5, a reflecting-red transmitting-blue-green beam combining mirror 6, a fluorescent unit 7, a red laser light source 9, etc.

The light beam emitted by the blue laser light source I 1 is incident to a light guide tube 12 through the reflecting-green transmitting-blue beam combining mirror 2, a light homogenizing plate I 4a, the reflecting-red transmitting-blue-green beam combining mirror 6, a red notch filter 10 and a lens group II 11 in sequence. The light beam emitted by the green laser light source 3 is incident to the light guide tube 12 through the reflecting-green transmitting-blue beam combining mirror 2, the light homogenizing plate I 4a, the reflecting-red transmitting-blue-green beam combining mirror 6, the red notch filter 10 and the lens group II 11 in sequence. Then, the blue laser light source I 1 and the green laser light source 3 are combined by the reflecting-green transmitting-blue beam combining mirror 2. After being combined, the blue laser light source I 1 and the green laser light source 3 transmit through the light homogenizing plate I4a, pass through the reflecting-red transmitting-blue-green combining mirror 6, go through the notch filter 10, and finally penetrate through the lens group I 11 to be coupled into the light guide tube 12.

The light beam emitted by the blue excitation light source 5 is incident to the fluorescent unit 7 through the light homogenizing plate II 4b, the reflecting-red transmitting-blue-green beam combining mirror 6 and a lens group I 8 in sequence. Then, the blue excitation light source 5 transmits through the light homogenizing plate II 4b, passes through the reflecting-red transmitting-blue-green beam combining mirror 6, and goes through the lens group I 8 to be incident on the fluorescent material of the fluorescent unit 7. The fluorescent material can be fluorescent ceramic, fluorescent crystal or fluorescent powder. The fluorescent material can be implanted into the optical path with a fluorescent wheel rotating from 20 Hz to 120 Hz, or can be implanted into the optical path with fluorescent crystal or fluorescent ceramic needing no rotation.

The light beam emitted by the fluorescent unit 7 is incident to the light guide tube 12 through the lens group I 8, the reflecting-red transmitting-blue-green beam combining mirror 6, the red notch filter 10 and the lens group II 11 in sequence. After being collected by the lens group I 8, color light of >532 nm generated by the fluorescent material under the irradiation of the blue excitation light source 5 enters into the reflecting-red transmitting-blue-green beam combining mirror 6, so as to perform light source wavelength combination with the blue laser light source 1 and the green laser light source 3.

The light beam emitted by the red laser light source 9 is incident to the light guide tube 12 through the light homogenizing plate III 4c, the red notch filter 10 and the lens group II 11 in sequence. Then, the red laser light source 9 transmits through the light homogenizing plate III 4c, and performs multi-wavelength light source combination with the blue laser light source I 1, the green laser light source 3 and the fluorescent excitation light source generated by the fluorescent material through the red notch filter 10. The laser light source synthesized by the red notch filter 10 is collected by the lens group II 11 to be coupled into the light guide tube 12.

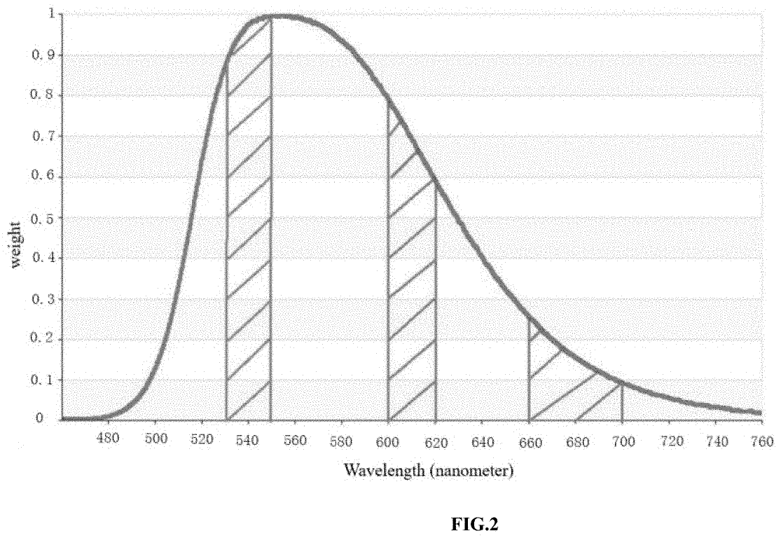

In order to make semiconductor laser diodes meet the requirements of color gamut Rec.2020, the embodiment of the present disclosure proposes a novel coupling integration scheme, in which RGB semiconductor laser diodes are integrated by a notch combining beam, and the laser fluorescence unit (>532 nm) is shown in FIG. 2. The curve spectrum diagram in the figure is the fluorescent powder excitation spectrum, in which the shaded part is the effective spectrum utilized by the large color gamut laser light source system integrated by a notch combining beam, which can achieve the requirements of large color gamut Rec.2020. At the same time, the present disclosure is high in cost performance and wide in working temperature adaptation range, which fully meets the requirements of batch and commercialization.

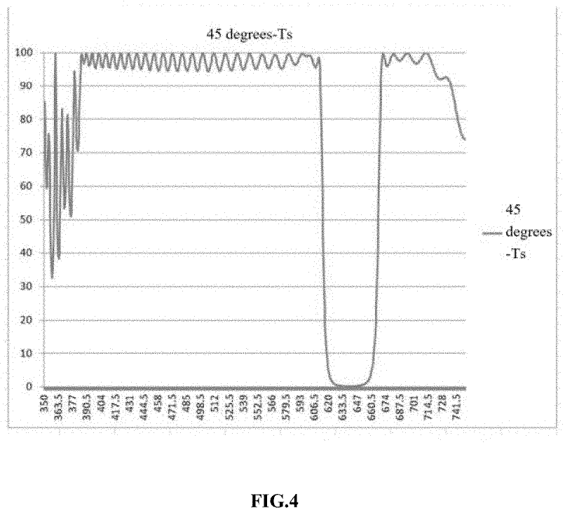

Specifically, the red notch filter has the optical characteristics shown in FIG. 4, specifically, reflecting the light source with a wavelength in the band of 620 nm-660 nm and transmitting the light source with a wavelength in the two bands of 400 nm-620 nm and 660 nm-700 nm.

The beams transmitted or reflected by the beam combining mirror are all incident at an angle of 45 degrees. The light sources of semiconductor RGB laser diodes have wavelengths of 448 nm, 455 nm, 465 nm, 520 nm, 525 nm, 638 nm, 639 nm, 640 nm and 642 nm, respectively. The laser fluorescent unit can be constructed by a blue laser diode and a fluorescent material adapted to the wavelength of the blue laser diode, and can excite and emit color light of >532 nm. By using the novel optical path as shown in FIG. 1 to implement multi-wavelength coupling, closely packing integration can be completed, and the laser integrated light source with large color gamut Rec.2020 can be realized, thus realizing the laser light source system with large color gamut, high brightness, small volume and stable performance.

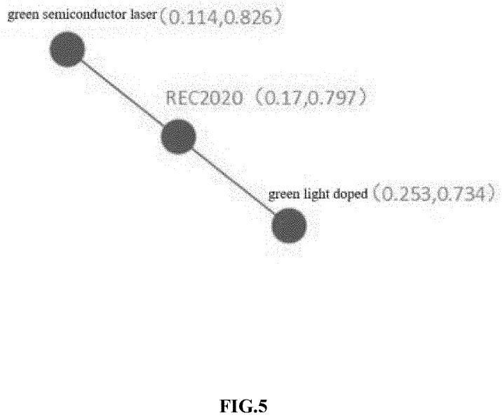

Taking green as an example: REC2020 requires the green vertex coordinates of color gamut to be (0.17, 0.797), while the current color coordinate of the green semiconductor laser is (0.114, 0.826). The use of the semiconductor cannot meet the requirements of REC2020 for color gamut, so it is necessary to change the light source or mix some green light with other color coordinates. The light sources with the two color coordinates are mixed to form a new color coordinate, which can meet the requirements of REC2020, as shown in FIG. 5. The specific calculation method is as follows: light of any color can be mixed by red, green and blue light in a certain proportion to give the same color light in visual sense, regardless of its spectral power distribution. This is the visual basis for human eyes to produce various colors. According to the basic principle of light distribution in light source colorimetry, given the light source color coordinates of light distribution G1(x1, y1), G2(x2, y2) and the light source color coordinates after light distribution G(x, y), the stimulation values A and B of the two light sources can be calculated by the following formula:

A*x1+B*x2=x_{∘}

A*y1+B*y2=y_{∘}

According to the stimulus value and visual function, the ratio energies E1 and E2 are further calculated as follows:

E1=A*y1/V(G1)_{∘}

E2=B*y2/V(G2)_{∘}

The ratio of light distribution source G1 is E1/(E1+E2), and the ratio of light distribution source G2 is E2/(E1+E2).

The integration scheme of a notch combining beam provided by the present disclosure realizes the coupling integration of multi-light color light sources and forms a laser light source integration system with a large color gamut. By providing a novel design scheme of an optical path and an optical component, the semiconductor RGB laser diode and the laser fluorescent unit are coupled and integrated in a closely packing way by means of a wavelength combining beam and a notch combining beam, which can effectively meet the requirements of color gamut Rec.2020.

In this specification, each embodiment is described in a progressive manner, and each embodiment focuses on the differences from other embodiments. It is sufficient to refer to the same and similar parts among each embodiment.

In the present disclosure, a specific example is applied to illustrate the principle and implementation of the present disclosure, and the explanation of the above embodiments is only used to help understand the method and its core idea of the present disclosure. At the same time, according to the idea of the present disclosure, there will be some changes in the specific implementation and application scope for those skilled in the art. To sum up, the contents of this specification should not be construed as limiting the present disclosure.

1. A large color gamut laser light source system integrated by a notch combining beam, comprising:
a blue laser light source I, a reflecting-green transmitting-blue beam combining mirror, a green laser light source, a blue excitation light source, a reflecting-red transmitting-blue-green beam combining mirror, a fluorescent unit and a red laser light source;
wherein:
a light beam emitted by the blue laser light source I is incident to a light guide tube through the reflecting-green transmitting-blue beam combining mirror, a light homogenizing plate I, the reflecting-red transmitting-blue-green beam combining mirror, a red notch filter and a lens group II in sequence;
a light beam emitted by the green laser light source is incident to the light guide tube through the reflecting-green transmitting-blue beam combining mirror, the light homogenizing plate I, the reflecting-red transmitting-blue-green beam combining mirror, the red notch filter and the lens group II in sequence;
t-le a light beam emitted by the blue excitation light source is incident to the fluorescent unit through a light homogenizing plate II, the reflecting-red transmitting-blue-green beam combining mirror and a lens group I in sequence;
a light beam emitted by the fluorescent unit is incident to the light guide tube through the lens group I, the reflecting-red transmitting-blue-green beam combining mirror, the red notch filter and the lens group II in sequence; and
a light beam emitted by the red laser light source is incident to the light guide tube through a light homogenizing plate III, the red notch filter and the lens group II in sequence.

2. The large color gamut laser light source system integrated by a notch combining beam according to claim 1, wherein the fluorescent material of the fluorescent unit is fluorescent ceramic, fluorescent crystal or fluorescent powder.

3. The large color gamut laser light source system integrated by a notch combining beam according to claim 2, wherein the fluorescent material generates color light of >532 nm under an irradiation of the blue excitation light source.

4. The large color gamut laser light source system integrated by a notch combining beam according to claim 1, wherein the beams transmitted or reflected by the beam combining mirror are incident at an angle of 45 degrees.

5. The large color gamut laser light source system integrated by a notch combining beam according to claim 1, wherein optical characteristics of the red notch filter are reflecting the light source with a wavelength in a band of 620 nm-600 nm and transmitting the light source with a wavelength in the two bands of 400 nm-620 nm and 660 nm-700 nm.

6. The large color gamut laser light source system integrated by a notch combining beam according to claim 1, wherein the fluorescent unit is constructed by a blue laser diode and a fluorescent material adapted to a wavelength of the blue laser diode.
